(19) United States
(12) Patent Application Publication
(10) Pub. No.: US 2002/0111832 A1
(43) Pub. Date: Aug. 15, 2002

(54) Method and apparatus for delivering a pharmaceutical prescription copay counselor over an internet protocol network

(76) Inventor: Robert Judge, Portland, OR (US)

Correspondence Address: MOSER, PATTERSON & SHERIDAN L.L.P., 595 SHREWSBURY AVE, FIRST FLOOR, SHREWSBURY, NJ, 07702, US

(21) Appl. No.: 10/047,470

(22) Filed: Oct. 23, 2001

Related U.S. Application Data
(60) Provisional application No. 60/242,535, filed on Oct. 23, 2000.

(51) Int. Cl. G06F 17/60

(52) U.S. Cl. 705/3

(57) ABSTRACT

A method and apparatus for providing a pharmaceutical prescription copay counselor to users. Specifically, the present invention describes the creation and delivery of a payment and copayment tool for physicians and consumers using computer assisted interactive resources over an Internet protocol network. The creation and delivery of this capability enables consumers and physicians, and others involved with prescription drug benefits, to identify lower cost and copay alternatives that are available within a third-party paid benefit or via cash payment using usual and customary pricing.

This application claims the benefit of U.S. Provisional Applications No. 60/242,535 filed on Oct. 23, 2000, which is herein incorporated by reference.

The present invention relates to an apparatus, system and concomitant method for providing a pharmaceutical prescription copay counselor to users, e.g., via a standalone computer kiosk, a local computer network and/or a global set of interconnected computer networks, i.e., the Internet or World Wide Web.

### BACKGROUND OF THE DISCLOSURE

The US healthcare market is under significant pressure to offer improved quality of care while capping costs. This pressure is felt by all sectors of the healthcare market such as the healthcare insurance companies, healthcare providers, pharmacies and the pharmaceutical companies.

Millions of Americans are learning to use the Internet in search of information and commerce. Consumers can now gain access to information pertaining to various health related matters, ranging from alternative medicine and therapy, support groups and healthcare related commerce, e.g., purchasing drugs.

Unfortunately, although the Internet is an extremely powerful vehicle to access information and to conduct business, it is neither an oriented information resource nor a personalized information resource. In other words, the Internet is a vast sea of resources that the consumer must continually filter to obtain relevant information. Such unoriented and unpersonalized approach causes the use of the Internet to be time consuming and inefficient. More particularly, in the field of personal healthcare, once a single piece of the relevant information is obtained, the consumers may still have many pertinent questions that must be answered, thereby leading to more searching.

For example, a consumer may be interested in trying an alternative medicine or therapy. Some of the relevant questions for such a consumer may encompass: 1) What exactly is the composition of the alternative medicine? 2) What are the side effects? 3) How will the alternative medicine react with medication currently taken by the consumer? 4) Is the alternative medicine appropriate in view of the consumer's prior medical history? 5) Where is the alternative medicine or therapy being offered? 6) What is the cost? 7) Will the consumer's insurance policy cover the alternative medicine or therapy? 8) Does the consumer's local pharmacy carry the alternative medicine? 9) Does the consumer's local pharmacy take online orders? 10) Are there any chat group. that discuss the alternative medicine or therapy in depth? and so on.

Thus, it would be very desirable to have a system and method that is designed to provide relevant and comprehensive health management resources and pharmacy services to consumers.

### SUMMARY OF THE INVENTION

In one embodiment of the present invention, a method and apparatus is disclosed that provides a pharmaceutical prescription copay counselor to users. Specifically, the present invention describes the creation and delivery of a payment or copayment tool for physicians and consumers using computer assisted interactive resources over an Internet protocol network. The creation and delivery of this capability enables consumers and physicians, and others involved with prescription drug benefits, to identify lower cost and copay alternatives that are available within a third-party paid benefit or via cash payment based on usual and customary prices. This capability, in turn, can be used by consumers and physicians to manage the amount of out-of-pocket expenses associated with their third-party paid benefits.

### BRIEF DESCRIPTION OF THE DRAWINGS

The teachings of the present invention can be readily understood by considering the following detailed description in conjunction with the accompanying drawings, in which:

FIG. 1 depicts a block diagram of an overview of the architecture of the present invention for providing personalized comprehensive health management resources and pharmacy services over a global set of interconnected computer networks, i.e., the Internet or world wide web;

FIG. 2 depicts a block diagram of the broad services that are provided by the present invention;

FIG. 3 depicts a more detailed block diagram of the four broad services of FIG. 2;

FIG. 4 depicts a block diagram of a flowchart of the method of the present invention for allowing a consumer to access the products and services of a health management and pharmacy service provider of the present invention;

FIG. 5 depicts a block diagram of a flowchart of the method of the present invention for allowing a patient to access the products and services of a health management and pharmacy service provider of the present invention;

FIG. 6 illustrates a block diagram of a flowchart of the method of the present invention for user profiling and behavior management;

FIG. 7 illustrates a block diagram of the architecture of an Internet pharmacist of the present invention;

FIG. 8 illustrates a block diagram of a method of the present invention for providing a pharmaceutical prescription copay counselor to users;

FIG. 9 illustrates a screen shot of the copay counselor resource allowing a user to search for a drug and calculate its price using an A-Z list;

FIG. 10 illustrates a screen shot of the copay counselor resource listing a plurality of drugs under the letter “V”;

FIG. 11 illustrates a screen shot of the copay counselor resource allowing a user to select the name of a drug;

FIG. 12 illustrates a screen shot of the copay counselor resource allowing a user to input the quantity of a drug;

FIG. 13 illustrates a screen shot of the copay counselor resource displaying the comparison of a requested drug versus its generic equivalent; and

FIG. 14 illustrates a block diagram of a method of the present invention for providing a pharmaceutical prescription copay counselor as a standalone price check query tool.

To facilitate understanding, identical reference numerals have been used, where possible, to designate identical elements that are common to the figures.

### DETAILED DESCRIPTION

The present invention is an apparatus, system and method that is designed to provide comprehensive health management resources and pharmacy services to consumers. In one illustrative embodiment, the system is an Internet health manager and e-commerce pharmacy providing highly personalized health management resources and pharmacy services for consumers.

The Internet is a global set of interconnected computer networks communicating via a protocol known as the Transmission Control Protocol and Internet Protocol (TCP/IP). The World Wide Web (WWW) is a fully distributed system for sharing information that is based upon the Internet. Information shared via the WWW is typically in the form of HyperText Markup Language (HTML) or (XML) “pages” or documents. HTML pages, which are associated with particular WWW logical addresses, are communicated between WWW-compliant systems using the so-called HyperText Transport Protocol (HTTP). HTML pages may include information structures known as “hypertext” or “hypertext links.” Hypertext, within the context of the WWW, is typically a graphic or textual portion of a page which includes an address parameter contextually related to another HTML page. By accessing a hypertext link, a user of the WWW retrieves the HTML page associated with that hypertext link.

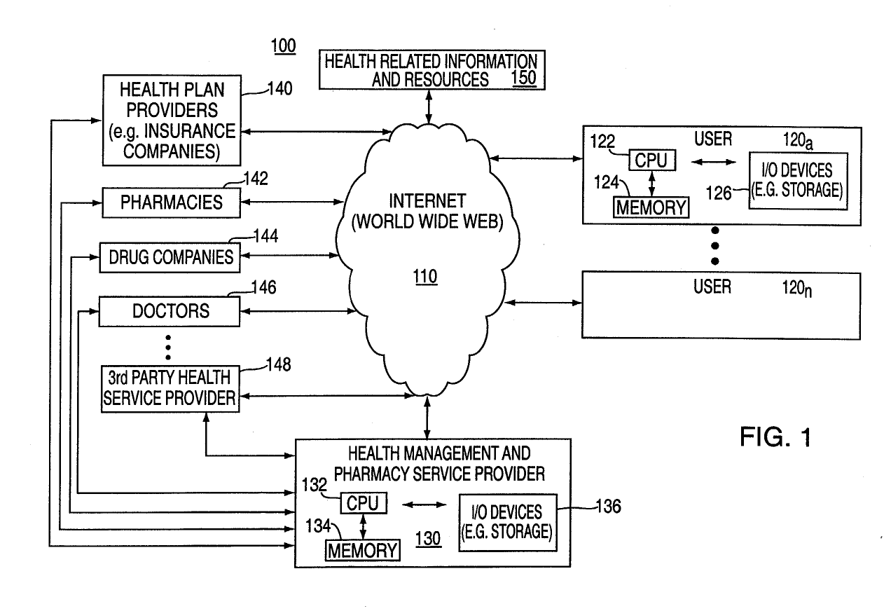

FIG. 1 depicts a block diagram of an overview of the architecture 100 of the present invention for providing personalized comprehensive health management resources and pharmacy services over a global set of interconnected computer networks, i.e., the Internet or World Wide Web. The architecture illustrates a plurality of users 120a-n, a health management and pharmacy service provider 130 of the present invention, a plurality of health service or health product providers 140-148, and an enormous amount of health related information and resources 150 that are all connected via the Internet.

Specifically, each user is an individual operating a general purpose computer or Personal digital assistant (PDA) or other Wireless Application Protocol controlled device 120 having a central processing unit (CPU) 122, a memory 124, and various Input/Output (I/O) devices 126. The input and output devices 126 may comprise a keyboard, a touch screen, a mouse, a modem, a camera, a camcorder, a video monitor, any number of imaging devices or storage devices, including but not limited to, a tape drive, a floppy drive, a hard disk drive or a compact disk drive. The general purpose computer allows the user to gain access to the services and information available on the Internet. Access to such services and products may include web sites operated by health plan providers (e.g., insurance companies and pharmacy benefit providers) 140, pharmacies 142, drug companies 144, health care providers (e.g., hospitals, clinics, doctors, nurses, etc.) and any other 3^{rd} party health service provider 148. Finally, a wealth of health related information and resources are summarily represented by reference numeral 150 which may include medical journals, reports, studies, chat groups, seminars, support groups and the like.

Unfortunately, although numerous healthcare information, products and services are available to a consumer over the Internet, the consumer must laboriously interact and seek out each of these pertinent healthcare information, products and services that are important to the user. Namely, such information, products and services are not collectively gathered and presented to the user. More importantly, critical health and personalized information of the user are often not correlated between different healthcare service providers.

To address such deficiencies, a health management and pharmacy service provider 130 of the present invention is provided. The health management and pharmacy service provider 130 is also implemented using a general purpose computer having a central processing unit (CPU) 132, a memory 134, and various Input/Output (I/O) devices 136. The input and output devices 136 may comprise a keyboard, a mouse, a modem, a camera, a camcorder, a video monitor, any number of imaging devices or storage devices, including but not limited to, a tape drive, a floppy drive, a hard disk drive or a compact disk drive. In the preferred embodiment, various functions of the health management and pharmacy service provider 130 as discussed below are implemented (in part or in whole) by a software application that is loaded from a storage device and resides in the memory 134 of the computer. As such, the health management and pharmacy service provider 130 and associated methods and/or data structures of the present invention can be stored on a computer readable medium. Finally, it should be noted that the general purpose computer of the health management and pharmacy service provider 130 of the present invention should be broadly interpreted to include one or more personal computers, servers, main frames and the like.

An important aspect of the present invention is the ability to provide a personalized and seamless health management and pharmacy service to a user. The user simply interacts with the health management and pharmacy service provider 130 to gain access to a personalized and comprehensive health management and pharmacy environment. Effectively, the health management and pharmacy service provider 130 becomes a health management portal to the user, where the enormous amount of health related services, products and information are processed and gathered into an organized and personalized presentation to the user.

Numerous advantages can be derived with this novel approach to health management. First, by integrating health plans with health management, greater efficiency is achieved in managing costs and providing faster and superior services to members of the health plan. For example, a pharmacy filling prescriptions for a member will have access to preferences of both the member belonging to the health plan and the health plan provider. To illustrate, health plans may want to let their diabetic members know they can receive free glucometers through their health plan benefit. Using pharmacy data from the health plan and, member preference information, members can receive information on this health plan benefit when they use the pharmacy, thereby satisfying the objectives of both parties while increasing cost efficiency.

Second, as health awareness among members grows, members become proactive with their health management. The health management and pharmacy service provider 130 of the present invention provides a vehicle for members to manage their own health, thereby providing a sense of control and a heighten sense of general health awareness. The present system will create an environment where specific consumer health profiles containing pharmacy records, preferences, disease states, preferences and other information can be created and dynamically updated to allow for greater specificity and increased relevancy on how health management information and pharmacy resources are delivered.

For example, numerous treatments for high blood pressure are currently available, but medical opinions still vary widely as to which treatment is preferred for certain situations. It has been noted that some doctors are influenced by strong marketing efforts by drug companies and, as a result, may prefer one treatment over another, while such treatment may be inappropriate and costly for health plans and their members, e.g., prescribing expensive calcium blockers instead of proven and less expensive beta-blockers with diuretics for mild hypertension. Thus, having a resource that allows consumers to understand the capabilities of their medications and the relative costs and alternatives available to them will encourage them to question their doctors on their reasoning in prescribing a particular treatment.

Third, since the health management and pharmacy service provider 130 of the present invention acquires health information of the members, health related information can be easily directed and personalized for individual members. For example, homeopathic information can be easily forwarded to members suffering from a particular disease who desire homeopathic remedies and treatments that are available. Another example is the ability to inform members of new health related services, e.g., the formation of a local support group or the availability of seminars being offered locally.

Fourth, since the health plan can be integrated with the health management and pharmacy service provider 130 of the present invention, insurance companies can readily receive feed backs from their members and disseminate new programs or initiatives, e.g., the introduction of new wellness programs from the health plan directed toward specific health conditions. The members affected with the aforementioned conditions can be notified of these programs and can be contacted by the appropriate case managers within the health plan to determine whether the new programs are appropriate. Thus, the present system will work with health plans to help their members make more informed decisions regarding their drug treatment and their overall health care management. These efforts may include messaging services customized to the clinical protocols of health plans. A major focus of the present system is providing robust messaging and data capture capability.

The system is unique in that it offers consumers personal and tailored health information, retail pharmacy commerce, and community functions to improve consumer health management. The system distinguishes itself from other emerging Internet pharmacies by delivering its services in partnership with health plans and other payors of prescription benefits.

Thus, the above advantages are only illustrative. Additional advantages will be readily apparent as various functions provided by the health management and pharmacy service provider 130 of the present invention are presented in detail below.

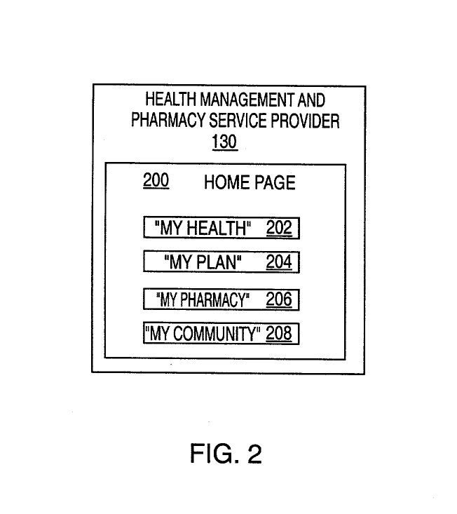

FIG. 2 depicts a block diagram of the broad services that are provided by the present invention. FIG. 2 illustrates a home page 200 of the present health management and pharmacy service provider 130. The home page embodies the profile selected by the consumer upon registration with the present system and reflects the consumer's known health conditions and particular health interests. It serves as the launching pad to the site's various health management tools, resources, products and services. After a consumer has registered with this site, this home page will be tailored to reflect the consumer's association with his/her health plan.

Additionally, health related information are collected and/or presented in four or more distinct sets of services, entitled “My Health”, “My Plan”, “My Pharmacy” and “My Community”. Specifically, through its Internet Pharmacy and partnerships with participating health plans and prescription benefit payors, the present system will offer the following services to consumers who visit its web site:

My Health

This service includes information tailored to an individual's health management needs. Consumers will be able to receive specific health information tailored to their health condition or interest, as well as store longitudinal health information for individual and family members in a proprietary secure and confidential environment. Health management tools and resources will be available based on the consumer's health profile to enable them to track and manage his/her health.

My Plan

This service includes information summarizing an individual's or family's health plan or prescription benefit provisions. It will assist plan participants with understanding their latest coverage policies as well as provide a place to go to understand policies and gain access to frequently asked questions (FAQs). Health plans and prescription benefit providers may use this facility to provide their clients with plan-specific information and resources to better manage their benefit programs and treatments.

My Pharmacy

This service allows consumers to create and manage an active medicine cabinet of pharmacy purchases, including prescription and non-prescription products through the system's web-site, as well as store historical data on their medicine cabinet of medications they have used previously. Additionally, through this service, consumers may purchase products, as well as enable connectivity to 3rd party payers for claims adjudication and transaction approvals. Consumer purchases may be fulfilled through the system's mail order pharmacy or, for added convenience, picked up by the consumer at a participating retail pharmacy “partner”. This area also provides a vehicle for information and recommendations about relevant products associated with a consumer's pharmacy regimen or interest to be communicated. In fact, an optional “e-pharmacist” can be activated and configured for each user as discussed below.

My Community

This service includes community functions, chats, bulletin boards and FAQs. It is designed to help consumers understand various issues concerning health management, as well as provide a forum for “experts” (pharmacists, physicians, health plan representatives and pharmaceutical representatives) to provide information and guidance on health management.

The present system will create significant commercial value for health plans while offering consumers tools and resources to effectively manage their health interests. Although the present invention is categorized into four distinct services or categories, it should be noted that the present invention is not so limited. Specifically, the four services can be grouped or additional services can be added or adapted in the future as addition of services from 3^{rd} party service providers are added into the overall system.

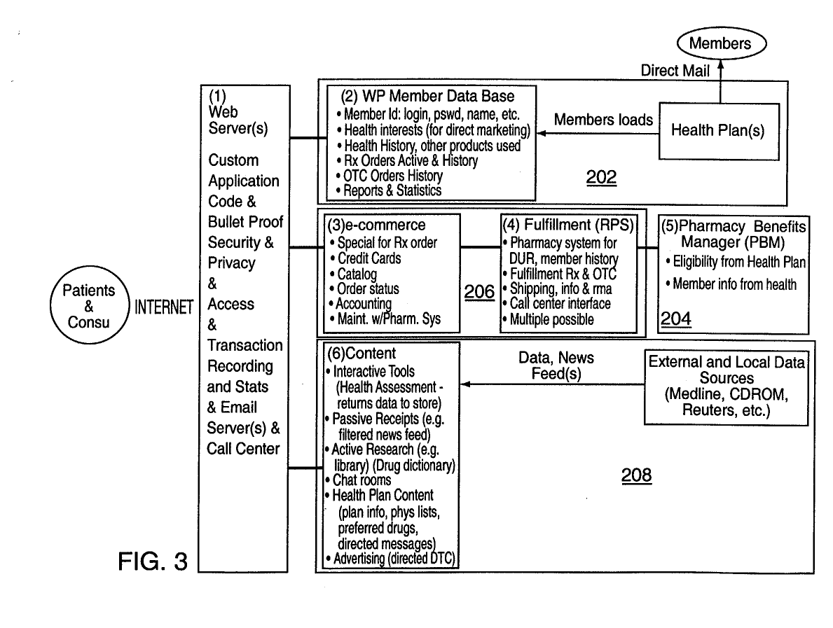

FIG. 3 illustrates a more detailed block diagram of the four different services of FIG. 2. Specifically, the information and/or services under “My Health” 202, include but are not limited to: member identification (i.e., login, password, name, etc.), health interest, health history, health related products used, prescription drug orders (active and history), over the counter (OTC) order history, health plan specific information of member (e.g., health plan name, health plan policy number, and etc.) and various reports and statistics. The information and/or services under “My Plan” 204, include but are not limited to: eligibility for coverage of treatments and drugs from health plan, member information supplied by the health plan provider, and health plan information (e.g., plan info, physician lists, preferred drugs, directed messages and etc.). The information and/or services under “My Pharmacy” 206, include but are not limited to: product information (e.g., a catalog of products, promotional specials), accounting information (e.g., credit card information, payment history), order information (e.g., a listing of products ordered, order status, fulfillment information, shipping information and etc.) and health history information. The information and/or services under “My Community” 208, include but are not limited to: receipt of health related information (e.g., from external and local data sources), interactive services (e.g., chat rooms, Q&A with health professionals), and health related advertising. It should be noted that since some information and/or services may be relevant to more than one grouping, such information may reside in multiple locations.

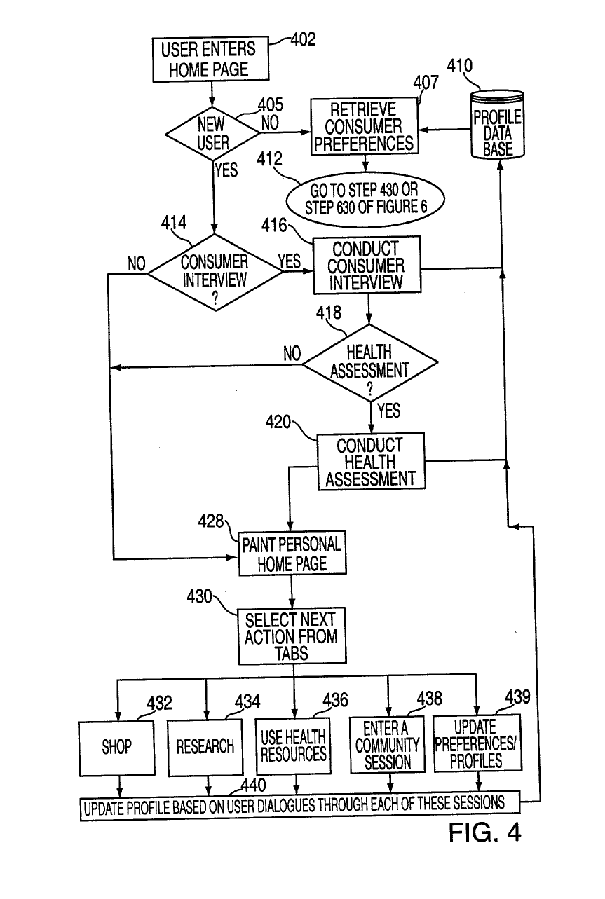

FIG. 4 depicts a block diagram of a flowchart of the method 400 of the present invention for allowing a “consumer” to access the products and services of a health management and pharmacy service provider of the present invention. It should be noted that in this disclosure, users that have health plan providers or payors of prescription benefits that are affiliated with the present health management and pharmacy service provider are referred to as “patients”. In contrast, those users that have no health plan providers or have health plan providers that are not affiliated with the present health management and pharmacy service provider are referred to as “consumers”. This distinction is made because the level of services are different between patients and consumers as provided below.

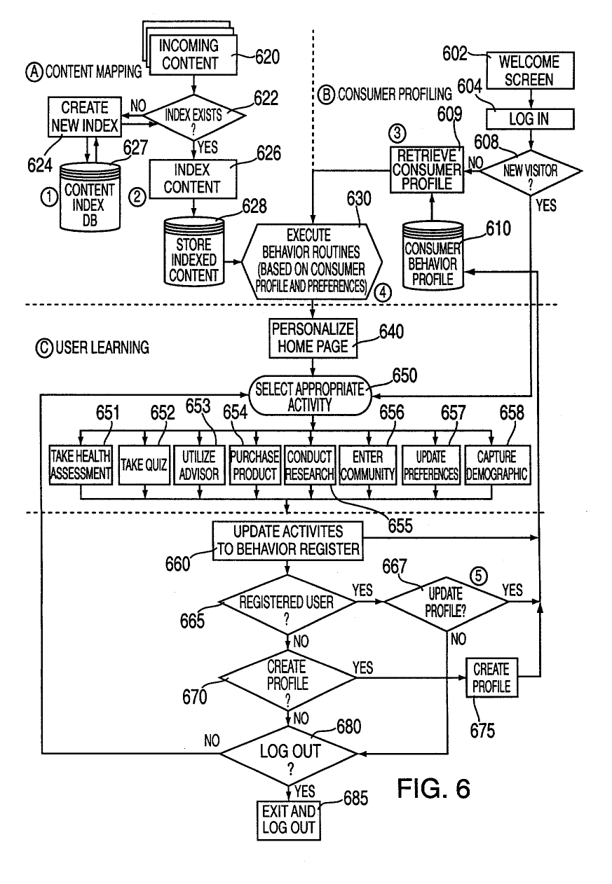

Method 400 starts in step 402, where a consumer enters a health management and pharmacy service provider's web site, i.e., home page. In step 405, method 400 queries whether the consumer is a new user. If the query is negatively answered, method 400 proceeds to step 407, where the consumer's preferences are retrieved from a profile database 410. Once the consumer is identified and his or her preferences are obtained, method 400 proceeds to step 430 below or step 630 of FIG. 6 (discussed below), where relevant contents are retrieved for the consumer. The consumer can then utilize other services provided by the health management and pharmacy service provider.

If the query is positively answered in step 405, method 400 proceeds to step 414, where method 400 queries whether the consumer is willing to undergo a consumer interview so that the consumer's personalized information can be utilized to provide better services by the health management and pharmacy service provider. If the query is positively answered, method 400 proceeds to step 416, where the consumer provides pertinent information in response to a questionnaire. If the query is negatively answered, method 400 proceeds to step 428, where a personal home page is “painted”, i.e., the home page presentation is in accordance with a layout preferred by the user. If no user preference is available, then a non-customized home page is provided.

In step 418, after the consumer interview is completed, method 400 queries whether the consumer is interested in having a health assessment be performed by the health management and pharmacy service provider based upon the information provided by the consumer. If the query is negatively answered, method 400 proceeds to step 428, where a personal home page is “painted”, i.e., the home page presentation is in accordance with a layout preferred by the user. If the query is positively answered, method 400 proceeds to step 420, where a health assessment is conducted for the consumer. The results from these assessments are used to personalized the pharmacy experience for the consumer.

It should be noted that health assessment tools can be uniquely designed for a particular application or can be licensed from other providers. For example, Gordian Health Solution of Golden, Colo. provides licenses for its health assessment tools.

In step 430, the consumer is then presented with all the available services, products and information in the form of tabs. Specifically, the consumer can shop in step 432, conduct research in step 434, use health resources in step 436, enter a community session in step 438 and/or update the consumer's preferences or profiles in step 439.

It should be noted that the consumer's inputs and actions are gathered and stored after steps 416, 420, and 440. The purpose is to gain insight and build a health profile of the consumer, which in turn is used to provide better services and behavior management as discussed below in FIG. 6.

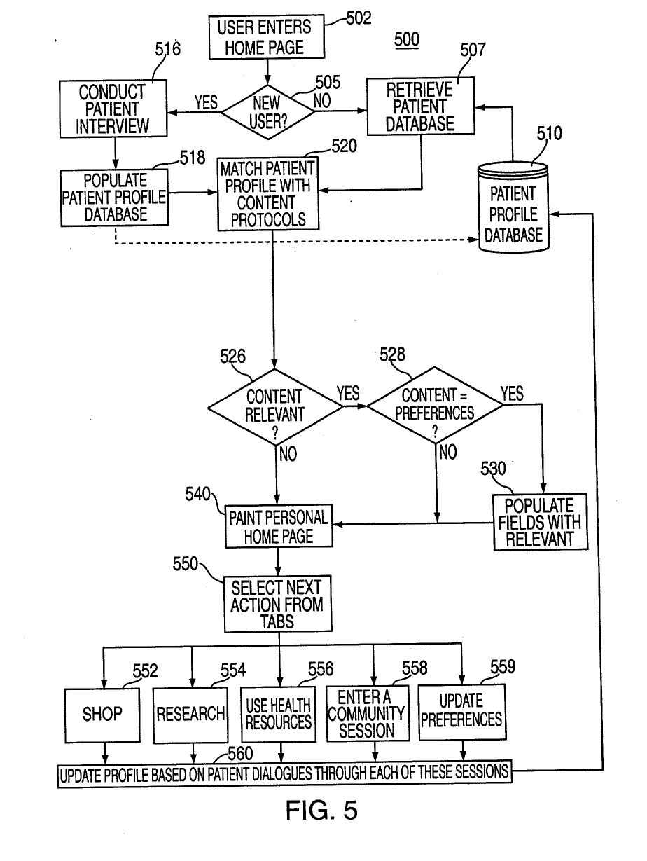

FIG. 5 depicts a block diagram of a flowchart of the method 500 of the present invention for allowing a “patient” to access the products and services of a health management and pharmacy service provider of the present invention. Method 500 starts in step 502, where a patient enters a health management and pharmacy service provider's web site, i.e., home page.

In step 505, method 500 queries whether the user is a new user. If the query is negatively answered, method 500 proceeds to step 507, where the patient's preferences are retrieved from a patient profile database 510. Once the patient is identified and his or her preferences are obtained, method 500 proceeds to step 520, where relevant contents are matched and retrieved for the patient. If the query is positively answered in step 505, method 500 proceeds to step 516, where the patient provides pertinent information in response to a questionnaire in accordance with a patient interview.

In step 518, after the patient interview, method 500 populates the patient information into the patient profile database 510. Method 500 then proceeds to step 520.

In step 526, method 500 queries whether the new content is relevant to the patient. This allows the system to identify relevancy of the content to be provided by the health management and pharmacy service provider using his or her profile and generate relevant information for the patient. If the query is negatively answered for new content, method 500 proceeds to step 540, where a personal home page is “painted”, i.e., the home page presentation is in accordance with a layout preferred by the patient, where only previously matched content is displayed. If the query is positively answered, method 500 proceeds to step 528.

In step 528, method 500 queries whether the new content is in accordance with the preferences of the patient. This allows the system to identify content that is preferred by the patient to be provided by the health management and pharmacy service provider using his or her profile and to generate information for the patient. If the query is negatively answered, method 500 proceeds to step 540, where a personal home page is “painted”, i.e., the home page presentation is in accordance with a layout preferred by the patient, where only previously matched content is displayed. If the query is positively answered, method 500 proceeds to step 530, where the new content is allowed to populate the relevant fields.

In step 550, the patient is then presented with all the available services, products and information in the form of tabs. Specifically, the patient can shop in step 552, conduct research in step 554, use health resources in step 556, enter a community session in step 558 and/or update the consumer's preferences or profiles in step 559.

It should be noted that the patient's inputs and actions are gathered and stored after steps 518 and 560. The purpose is to continually gain insight and build a health profile of the patient, which, in turn, is used to provide better services and behavior management as discussed below in FIG. 6.

FIG. 6 illustrates a block diagram of a flowchart of the method 600 of the present invention for user profiling and behavior management. Method 600 illustrates the manner in which a user's profile is updated and used to match relevant content and to effect behavior management.

Method 600 starts in step 602 and proceeds to step 604 where a user logs in with the health management and pharmacy service provider. In step 608, method 600 queries whether the user is a new user. If the query is negatively answered, method 600 proceeds to step 609, where the user's (consumer or patient) preferences are retrieved from a user behavior profile database 610. Once the user is identified and his or her behavior profile is obtained, method 600 proceeds to step 630, where a behavior routine operates on the user behavior profile and user preferences to match relevant content for the user from an indexed content 628.

It should be noted that steps 620-626 operate independently from other steps of method 600. Namely, new health related content is received by the health management and pharmacy service provider in step 620. If the new content is not previously categorized or indexed (using meta-tags) for a particular user of the system, a new index is created in step 624 and the new content is stored in storage 627. However, if the new content has previously been categorized or indexed for a particular user of the system, then the content is stored in storage 628 as indexed content. Thus, steps 620-626 can be performed online or offline, and do not require the user to be logged on. The content will be stored in storage 628 pending the next “sign on” by the user.

A unique aspect of method 600 is that the matched content is generated from both preferences of the user and the user's “learning” as detected by the health management and pharmacy service provider in providing services to the user. For example, if a user identifies him/herself as having high cholesterol in his/her profile and also identifies an interest in resources to assist with managing this condition, and the health management and pharmacy service provider 130 identifies a sponsored activity (by the member's health plan) providing free cholesterol screening at a local retail establishment, then the behavior management routine in step 630 may match a content dealing with the availability of this program being offered at the local retail establishment upon the user's next visit to the portal. This unique service (behavior management) independently promotes and matches health awareness with services provided by third party health care provider. Both parties benefit because the member is made aware of locally available services and the third party health care provider can advertise their services to members who already have shown an initial interest. In other words, FIG. 6 illustrates a method that not only match content based upon the preferences specified by the user, but anticipates and learns the interest of the user by monitoring the user's use and access of resources on the site.

Returning to FIG. 6, in step 640, method 600 paints a personal home page, i.e., the home page presentation is populated with content matched in accordance with the user's behavior profile. In step 650, the user is then presented with all the available services, products and information in the form of tabs. Specifically, the user can take a health assessment in step 651, take a quiz in step 652, utilize an advisor or health resources in step 653, shop in step 654, conduct research in step 655, enter a community session in step 656, update the user's preferences or profiles in step 657 and/or capture demographic information in step 658.

In step 660, the user's activities are captured and used to update a behavior register in the storage 610. Method 600 then proceeds to step 665.

In step 665, method 600 queries whether the user is a registered user. Namely, a user may still utilize the services and resources of the health management and pharmacy service provider without being registered as a registered user or “patient”. However, the ability to provide enhanced services to the user can be increased if the user is willing to register with the health management and pharmacy service provider. If the query is positively answered, then method 600 proceeds to step 667 where method 600 queries whether the registered user's profile should be updated based upon the activities that occurred on the site. If the query in step 667, is positively answered, then method 600 updates the user's profile in storage 610. If the query in step 667, is negatively answered, then method 600 proceeds to step 680, where the user can decide whether to end the session. This feature allows the registered user the option to determine whether his or her activities at the site should be used to update his or her profile for each session.

Returning to step 665, if the query is negatively answered, then method 600 proceeds to step 670, where method 600 queries whether a profile should be created. If the query is positively answered in step 670, then method 600 proceeds to step 675, where a user profile is created and stored in storage 610. If the query is negatively answered in step 670, then method 600 proceeds to step 680, where the user can decide whether to end the session. If the user decides to leave the site, the user exits and logs out in step 685.

In sum, the health management and pharmacy service provider as described in FIGS. 4-6 provides a number of unique features. First, within this novel environment, the present invention describes:

1) An Internet solution where individual's health and commerce information is stored in a longitudinal database that is accessible only to that individual or his assignee(s). Namely, an individual can manage his or her own health or can assign another (e.g., caretaker) to perform the management task, e.g., as in the case of minors and the elderly.

2) Individual profiles are created through a variety of consumer initiated and web site initiated content and events, such as health and risk assessments, health promotion materials, medical self care, informed decision making resources, disease management resources, alternative health information, drug and medical information, and health management and tracking tools.

3) Individual preferences are chosen, assigned, and tracked to describe the type, frequency and method content is provided to individuals based on their profiles.

4) A web site's content is matched to the longitudinal profile described in (1) above to ascertain those items that may be of interest to a site visitor.

5) Suggested behaviors are made relative to future navigation and commerce by filtering the content from (4) above through the preferences from (3) above, ensuring only that information that is relevant to an individual consumer's profile is displayed.

6) Tracking of suggested behaviors (from 5) above is made and subsequently tracked so predictive modeling can be carried out, tracked, and integrated into the patient database for future content ‘push’ decisions. This is accomplished to provide users with smarter suggestions that over time they are more likely to act on and not overburden the user with suggestions that could compromise their effectiveness.

To execute the present invention, the present system allows health plans and other payors of prescription benefits to participate in a partnered relationship to provide pharmacy services for their clients or members. These important relationships will focus on directing health plan patient populations to an Internet resource that offers content, community and commerce consistent with the health plan's benefits program.

“e-Pharmacist”

Another unique aspect of the present invention is that the present health management and pharmacy service provider provides an optional function or resource that equates to a personal “e-pharmacist” to users. Specifically, the above description provides a method for a broad health management of an individual. However, this similar concept is deployed at a more refined level directed toward managing the pharmaceutical need of the user. Namely, a method for creating a personalized electronic pharmacist via an interactive web site and online pharmacy environment is disclosed. This function can be deployed within the section labeled “My Pharmacist” as discussed above.

Specifically, the “e-pharmacist” function delivers the following elements:

1) A user defined e-pharmacist with whom an Internet or online user may interact to conduct pharmacy commerce and receive directed information and other resources available within a web site;

2) A unique and integrated model to identify individual health requirements using an Internet Protocol session;

3) The ability to determine appropriate resources resident within the hosted Internet Protocol session based on an understanding or inference of individual health conditions, interests, diagnoses, and/or risks;

4) The ability to propose one or more of these alternative resources; and

5) Direct behavior via the integration of these capabilities.

This resource will be made actionable for users of an IP network session by a context sensitive pop-up window or an interrogative device that is delivered electronically that enables the hosting service to understand the personalization attributes of the online user and interact with this individual via the IP session. Namely, the user can optionally activate and configure the e-pharmacist.

The e-pharmacist resource includes a process to monitor and store results of an individual IP session activities in terms of the resources that are accessed and utilized. Namely, the e-pharmacist resource has the ability to access and update an individual or group profile within a web site domain, and the ability to match and recommend resources that are available within the web site using a matching algorithm and “if/then” scenarios using an individual's historic interaction with the web site resources and providing direction to other relevant resources that are available within the web site.

Several broad elements are included within this e-pharmacist architecture.

1. Learning Ability to Anticipate and Suggest Activities

The e-pharmacist resource has the ability to render ever more relevant resources for the consumer based on a constant monitoring of activities within the site and selecting those resources that are most germane using a number of personalization characteristics such as resource relevance preferences, preferred learning style, stage of interest, etc. Specifically, in operation these may include: 1) link to user's personal profile, 2) ability to store results, 3) ability to log site activities, 4) index content filtered against consumer use characteristics to render selective content, 5) link site resources together for “if, then” scenarios based on consumer's interaction in web site. Specifically, although the e-pharmacist resource has information concerning known and inferred conditions of the user, by properly monitoring the activities of the user, the e-pharmacist resource can also update “inferred conditions” of the user, e.g., a “known condition” can be diabetes and an “inferred condition” can be obesity based upon activities of the user.

To achieve this element, the e-pharmacist resource performs monitoring and update functions. Monitoring functions include collecting data based on each user's site activities, i.e., purchases, library queries, site events attended and tools used on the site. For example, each tool will have an overall and sub-use data collection points (e.g., an Health Risk Assessments (HRA) will be monitored for being utilized, for its overall results, and for answers to individual questions).

Updating functions include updating an individual's metric profile with activity/metrics with three distinct levels: primary, secondary and tertiary. A primary level comprises a confirmed health condition, e.g., diabetes. Information classified as primary are given the greatest weight.

A secondary level comprises types of activities (e.g., purchases, research, or attend site events detected by the e-Pharmacist). These activities are used to determine “inferred conditions”.

Finally, a tertiary level comprises level of relevance (e.g., high, medium and low). More specifically, upon activating and configuring the e-pharmacist, a user must provide or grade relevance with regard to his or her activities to products, site events, and content. For example, a user can specify a high interest in homeopathic products to help treat an affliction and a low interest in community events for that same affliction. This relevance rating can be implemented for condition the user wants to manage or explore or alternatively, can be configured globally when e-pharmacist is initially activated, e.g., designating all prescription drugs as being “high relevance” and all community events as being “low relevance”. Namely, the e-pharmacist resource will update the user's “inferred condition profile” with relevant conditions and level of inference based on metrics in the “metric profile”. It should be noted that the “metric profile” is only used by the e-pharmacist resource. It should also be noted that the above disclosed capabilities can be grouped or used individually to provide selective e-pharmacists functions.

2. Provide Recommended Services

The e-pharmacist resource has the ability to isolate site resources down to an individual consumer's level of interest. Based on an understanding of a consumer's metric profile (both known and inferred), the e-pharmacist would help guide the consumer through the web site's resources. This capability would approximate the usefulness of a software “Assistant” or “Wizard” to help the user with context sensitive relevant assistance. These may include, but are not limited to: 1) relevant shopping recommendations (appropriate items/information: push), 2) complementary reading suggestions (push), 3) recommend site resources based on profile and experiences, 4) online forums & events, 5) refer to additional resources so consumer can explore site to his level of need/interest, 6) reminder services (for commerce, community or site resources (e.g., take a health risk assessment), 7) submit questions to the e-pharmacist via IP session at the web site, and 8) access to FAQs.

Namely, based on “informed” and “inferred” conditions, the e-pharmacist has the ability to isolate site resources to the individual consumer's area of interest and recommends additional resources and alternatives. For example, the e-pharmacist may recommend site activities using consumer's “on and off” preferences and “relevance meter” settings. Using resource relevance, consumers will score information for each category on a 1-5 scale. Only information that minimally meets the consumer's score will be recommended.

Alternatively, the e-pharmacist can refer resources using a relevance score assigned to the resource for each health condition and the relevance preferences of the consumer to determine appropriate referenceable resources. For example, all resources on the site are rated in accordance with different health conditions. Thus, a resource directed for pregnancy, e.g., recommendation of neo-natal vitamins during pregnancy will be rated very high (5 in a scale of 1-5), if the user identifies herself to be pregnant. However, if the user in not pregnant and is suffering from heart disease instead, then the same neo-natal vitamin will be rated very low (1 in a scale of 1-5) by the e-pharmacist.

Additionally, the e-pharmacist also provides routing to relevant site resources based on indexing of site resources around conditions. Site resources are organized according to health conditions. All resources will receive a relevance score related to the indexed health condition. The e-pharmacist will navigate according to this relevance matrix for health conditions and associated site resources.

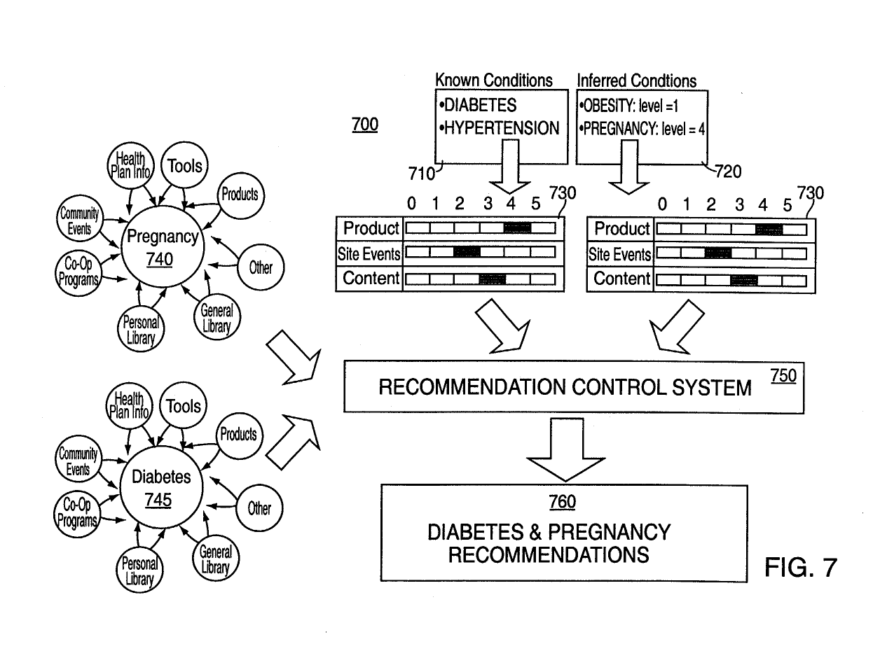

FIG. 7 illustrates a block diagram of the architecture of an Internet pharmacist of the present invention. Specifically, the resource e-pharmacist starts with “known conditions” 710, and then continually builds its knowledge to deduce “inferred conditions” 720. The resource e-Pharmacist will also access the relevance ratings provided by the user with regard to product, site events and content 730. Finally, the resource e-pharmacist will monitor the activities of the user with regard to resources that are associated with the conditions of the user, e.g., pregnancy 740 and diabetes 745. All these information and monitored activities are provided to a recommendation control system 750 of the resource e-pharmacist, which, in turn, generates user specific recommendation, e.g., diabetes and pregnancy recommendations 760.

3. Friendly and Easy to Use

The e-pharmacist resource satisfies at least two use characteristics. The first is providing an electronic resource that supplements the pharmacist in a market that is suffering from an explosion in prescriptions and a corresponding shortage in licensed pharmacists. The second, is to earn a trusted relationship with the consumer so the resource can leverage its resources for his/her benefit. To achieve this, the e-pharmacist resource may include the following features: 1) gear to 8th grade or earlier reading style for all site elements, 2) provide the ability to explore more complex and less complex resources, 3) keep dialogues with the consumer brief in all areas (including profile), 4) provide short cuts to functions, 5) make resources of site informative, 6) remember their previous activities so consumer can easily return to what they were doing, 7) remember their most frequently used activities so consumers can initiate these routines more quickly and 8) challenge the consumer's understanding of his/her health and ways to protect/improve it.

4. Convenient Access (24*7)

The e-pharmacist resource is available 24 hours a day and seven days a week. This provides convenience and promotes member participation.

5. Ask Your Pharmacist

The e-pharmacist resource has the ability to get your questions answered in a private and responsive manner. These may include: 1) submit questions to the e-pharmacist via IP session at the web site, 2) access to FAQs, 3) access to bulletin board and have ability to read and post questions/responses, 4) email the pharmacist (target 24-hour response time), 5) telephone the pharmacist (real-time live pharmacist), 6) allow your pharmacist to see your pharmacy record, 7) provide feedback to the web site on topics and relevancy, and 8) query and establish session dialogues.

Additionally, the e-pharmacist resource may also perform a drug utilization review to check other medications used by the user. For example, a novel drug utilization review method is disclosed in a copending U.S. patent application entitled “Method, Apparatus And System For Providing A Drug Utilization Review That Integrates Non-Prescription Items”, with Ser. No. 09/689,268, filed Oct. 12, 2000 and is herein incorporated in its entirety by reference.

6. Method to Update Personal Profile

Inherent in the session dialogue, the e-pharmacist has the ability to update an individual's profile. For example, an individual's profile can be updated with 1) inferred topics that have an “accuracy” measure assigned to them and 2) results of queries to individuals about their level of interest by topic, and 3) updates from specific health information feeds from the individual's health plan. Topic resources are classified by category.

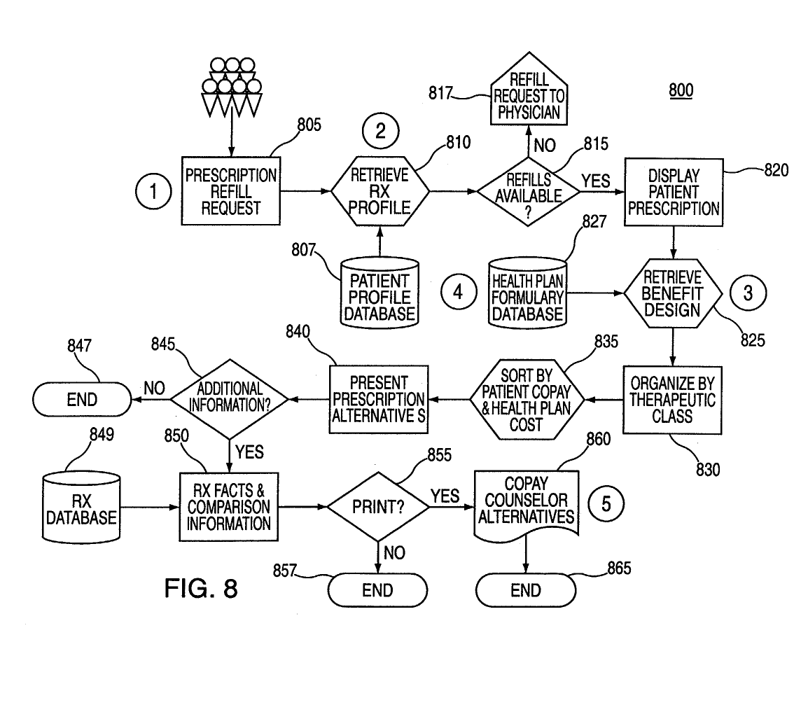

Furthermore, FIG. 8 illustrates a block diagram of a method of the present invention for providing a pharmaceutical prescription copay counselor to users. The present invention describes the creation and delivery of a copay tool for physicians and consumers using computer assisted interactive resources over an Internet protocol network. The creation and delivery of this capability enables consumers and physicians, and others involved with third-party paid benefits, to identify lower copay alternatives that are available within a third-party paid benefit. This capability, in turn, can be used by consumers and physicians to manage the amount of out-of-pocket expenses associated with their third-party paid benefits. This function can also be deployed within the section labeled “My Pharmacist” 206 as disclosed above or as a separate standalone function.

To illustrate, one application is in the administration of prescription drugs. This resource may be applied to help consumers and Healthcare Practitioners identify lower cost medications that are available through their health plan (e.g., via a 3^{rd} party reimbursed prescription benefit) or via a “cash pay” basis. The copay counselor can be implemented having the following elements and/or features:

1) An interactive computer resource that suggests therapeutic and generic alternative prescription medications based on the price of a medication;

2) An interactive computer resource that suggests alternative prescription medications (e.g., therapeutic and/or generic alternative medications) based on the copay amount the consumer would contribute as part of a tiered copay or defined contribution prescription benefit;

3) A user-invoked search tool that can be accessed to search for prescription products using Usual and Customary prices (U&C), Average Wholesale Price (AWP), Maximum Allowable Cost (MAC) or 3^{rd} party reimbursed prescription benefit formulary alternatives;

4) The ability to display one or more alternate medications that may be appropriate for substitution using Usual and Customary prices (U&C), Average Wholesale Price (AWP), Maximum Allowable Cost (MAC) or 3^{rd} party reimbursed prescription benefit formulary alternatives;

5) A calculator tool that enables consumers to identify the cost savings to them and the 3^{rd} party payor of the prescription benefit by selecting a relevant product from the 3^{rd} party payor formulary, where the calculation can be based on unit of dose and strength of medication;

6) Links to associated patient facts and comparison information, drug monographs and other information sources for the available prescription medications or treatments; and

7) A dialog tool enabling the consumer to log prescriptive therapy options (e.g., therapeutic and generic alternative prescription medication alternatives) for discussion with his/her physician about alternative treatments that may be appropriate.

This service accomplishes the dual objectives of helping consumers save considerable money for chronic medications, while helping 3^{rd} party payors lower their pharmacy per member per month costs.

This resource will be made actionable for consumers using an IP network session by a context sensitive pop-up window or an interrogative device delivered electronically (e.g., interrogative screens to navigate a session dialogue or by using context sensitive HTML windows to populate results from a hosting service) that enables the hosting service to receive queries about a medication and returns results and options using Usual and Customary Prices (U&C), Average Wholesale Price (AWP), Maximum Allowable Cost (MAC), or 3rd party reimbursed prescription benefit formulary alternatives. The communication dialogue between the consumer and his/her plan formulary and/or a price file is maintained via this IP session.

It should be noted that Average Wholesale Price (AWP) means the usual cost of pharmaceuticals charged to a pharmacy provider by a large group of pharmaceutical wholesale suppliers. For example, reimbursement rate can be set to AWP-12%+$2.25 dispensing fee.

Maximum Allowable Cost (MAC) is defined as a list of Prescription drug Products covered at a Generic Product price. This list is periodically updated with new generic drugs as they become available. It is typically established by the Centers for Medicare & Medicaid Services (CMS) as the highest amount reimbursed for prescriptions which are covered under the terms of the patient's contract.

Usual & Customary Price (U&P) is defined as the price charged or accepted as payment for a given volume of drugs (legend or non legend) to any purchaser or reimburser. Finally, formulary is a continually updated list of medications and related information, representing the clinical judgment of physicians, pharmacists and other experts in the diagnosis and/or treatment of disease and promotion of health.

Thus, the present invention can be implemented as a resource or function of the health management and pharmacy service provider 130 as discussed above. Alternatively, the present invention can be implemented as a “standalone” service or resource for managing prescription payments and copayments in general.

As prescription prices increase and employers change the pharmacy benefit they cover for their employees to include higher co-payments and double and triple co-payments for prescription products, greater financial responsibility and decisions for prescription benefit coverage is being placed on individuals and employees. Wellpartner's Copay Counselor™ seeks to provide consumers with the information they require to assist them with having informed discussions with their physicians to explore the appropriateness of alternative prescription medicines that have lower consumer co-payments.

Prescription co-payments by employees with 3^{rd} party prescription benefits are now in the range of $20 to $30 for prescriptions. As such, it has become an increasingly important financial issue for many 3^{rd} party payor benefit enrollees to know that there may be medications in the same therapeutic category on their prescription benefit formula that have lower co-pays.

It should be noted that a formulary is often defined as a list of prescription medications generally covered under a pharmacy benefit plan subject to applicable limits and conditions. Some formularies include brand-name and generic drugs that have been approved by the FDA as safe and effective. Most drugs listed on the formulary are subject to manufacturer volume discount arrangements under which a 3^{rd} party provider may receive financial consideration. However, such financial consideration may not be readily available to 3rd party benefit enrollees, especially, at the time when the 3rd party benefit enrollee is actually filling the prescription with a pharmacist.

In contrast, the Copay Counselor allows 3rd party benefit enrollees who use the web resources of this invention to track the status of active medications for which they have outstanding refills. Once the enrollee has gained access to his/her personal prescription profile, he/she will see all the active medications they presently have and which of these have refill amounts outstanding. Certain of these medications may be highlighted, or differentially called-out within the enrollee's profile. These highlighted medications indicate that other medications exist within the same therapeutic class and have lower co-payments than the medication the enrollee presently has prescriptions for. The enrollee can click on highlighted medications and the Copay Counselor will display information about the medications within the highlighted prescription's therapeutic class, including the product name, its generic name, description, 3^{rd} party payor cost, and enrollee co-pay amount.

The displayed information can be printed or emailed to the enrollee's physician. The enrollee may use this information in a subsequent phone call or office visit with his/her physician to explore whether a lower copay alternative may be appropriate as a replacement prescription. If the physician does so, the enrollee experiences a cash savings as the difference between the copays. The 3^{rd} party payor saves the difference between the previously prescribed medication and the new, less expensive or generic prescription.

Once an enrollee has signed into and registered with the Health Management And Pharmacy Service Provider 130, the Copay Counselor automatically emails enrollees when it identifies co-payment differentials for medications within the same therapeutic category. This feature is also included as part of this disclosure.

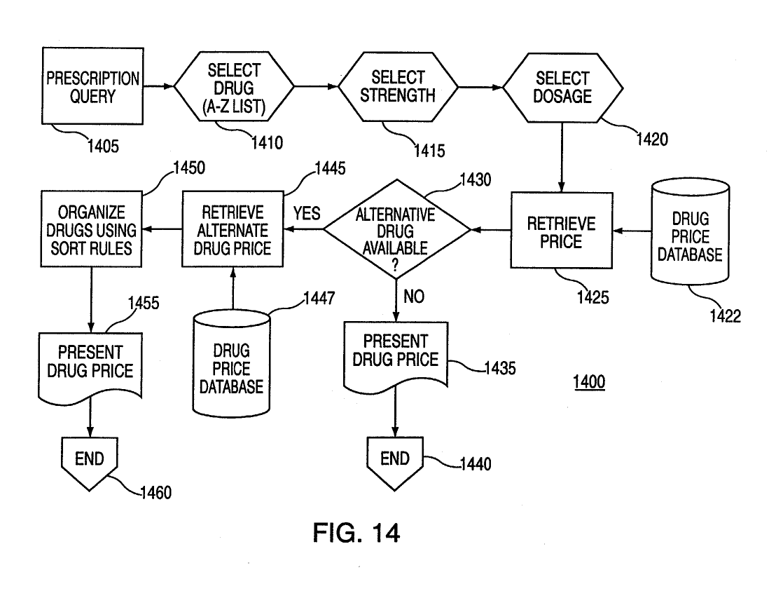

Alternatively, this resource can be made available to a user who simply desires to look for less expensive brand name or generic alternatives based on a specific medication by name. This embodiment is disclosed below with reference to FIG. 14.

Specifically, FIG. 8 illustrates a block diagram of a method 800 of the present invention for providing a pharmaceutical prescription copay counselor to users. Specifically, in one embodiment, method 800 is started when a user enters a new prescription request or a prescription refill request for a particular drug in step 805. However, as discussed above, method 800 can be triggered in accordance with other triggering criteria, e.g., a user invoked search command, a prescription forwarded by a physician of the user, or the availability of a new medication (generic or brand name) from a drug company that relates to drugs currently prescribed to a user.

In step 810, method 800 retrieves the drug's profile. Namely, method 800 retrieves all the information pertaining to the drug that is currently being requested including its generic or brand name equivalents. Additionally, the patient profile database 807 is also consulted. Namely, method 800 verifies other user information that may be pertinent to the present prescription request, e.g., potential interaction with other medications that the user is presently taking. In fact, the display of availability of lower cost generic or brand name equivalents to a requested drug can be limited if such equivalents are found to pose some potential adverse effect when used in combination with other drugs taken by the user.

In step 815, method 800 queries whether a prescription to fill or refill the requested drug is present for the user. If the query is answered positively, method 800 proceeds to optional step 820 where the patient prescription is displayed optionally. If the query is answered negatively, method 800 proceeds to step 817 where a prescription request is forwarded to the user's physician.

In step 825, method 800 retrieves the benefit design for the user, e.g., retrieving the prescription drug plan for the user from health plan formulary database 827. Namely, the present invention provides the ability to link a user to a specific price file based on a registration affiliation. Method 800 retrieves user pharmacy profile to display the correct price. It can also retrieve information from the user's prescription benefit provider (formulary and benefit information) to identify alternate medications within a same therapeutic class of prescription as provided or recommended by the user's prescription benefit provider.

In step 830, method 800 organizes therapeutic class of potential alternatives to the requested drug. Therapeutic class means approved drug products with Therapeutic Equivalence Evaluations (the List), approved on the basis of safety and effectiveness by the Food and Drug Administration (FDA) under the Federal Food, Drug, and Cosmetic Act (the Act) and referenced in the Electronic Orange Book of Approved Drug Products with Therapeutic Equivalence Evaluations by the FDA.

In step 835, the potential alternatives to the requested drug are sorted in accordance with patient, copayment and/or health plan cost and displayed in step 840. For example, the alternatives are listed in the order of the lowest copay to the highest copay. Alternatively, the alternatives can be further listed using a second sort order in accordance with health plan cost, e.g., the user may incur the same copay for two generic alternatives, but the 3^{rd} party provider may have a better financial arrangement with one generic drug manufacturer then the other generic drug manufacturer. In this situation, the generic equivalent with the lower cost to the 3^{rd} party provider will be listed first or above the other generic equivalent. This is important because the user is now able to see that his out of pocket expense is the same for both generic alternatives, but his selection of one generic alternative over another alternative may provide a cost saving to his health care insurance provider. This feature allows the user to actively assist his health care insurance provider in keeping health insurance cost down, while still receiving the proper medication. Ultimately, such savings will translate to lower health insurance premium to the user or the user's employer. In fact, as the practice proliferates, it will promote competition among pharmaceutical companies to further reduce cost for drugs since consumers are now empowered to assist in managing health care cost at the point of filling their prescriptions. Without the present copay counselor, the user has little knowledge to guide him in the selection of alternatives.

Results can be accompanied with a message identifying lower cost alternatives and suggesting the individual review this information with his/her Healthcare Practitioner for appropriateness. When information is displayed electronically, the individual is provided with links to additional information on prescription alternatives to assist the patient with understanding, such as Patient Facts and Comparisons, and drug monograph information, as well as the ability to request the prescription be filled or transferred with the alternate medications

In step 845, method 800 queries whether the user wants additional information pertaining to the requested drug and its alternative equivalents. If the query is answered negatively, method ends in step 847. If the query is positively answered, then method 800 proceeds to step 850, where the information such as drug facts and/or comparison information between the drugs are presented to the user for review.

In step 855, method 800 queries whether the user wants to print the additional information pertaining to the requested drug and its alternative equivalents. If the query is answered negatively, method ends in step 857. If the query is positively answered, then method 800 proceeds to step 850, where the information such as drug facts and/or comparison information between the drugs are printed or optionally emailed to the physician selected by the user for approval of the listed alternatives. Method 800 then ends in step 865.

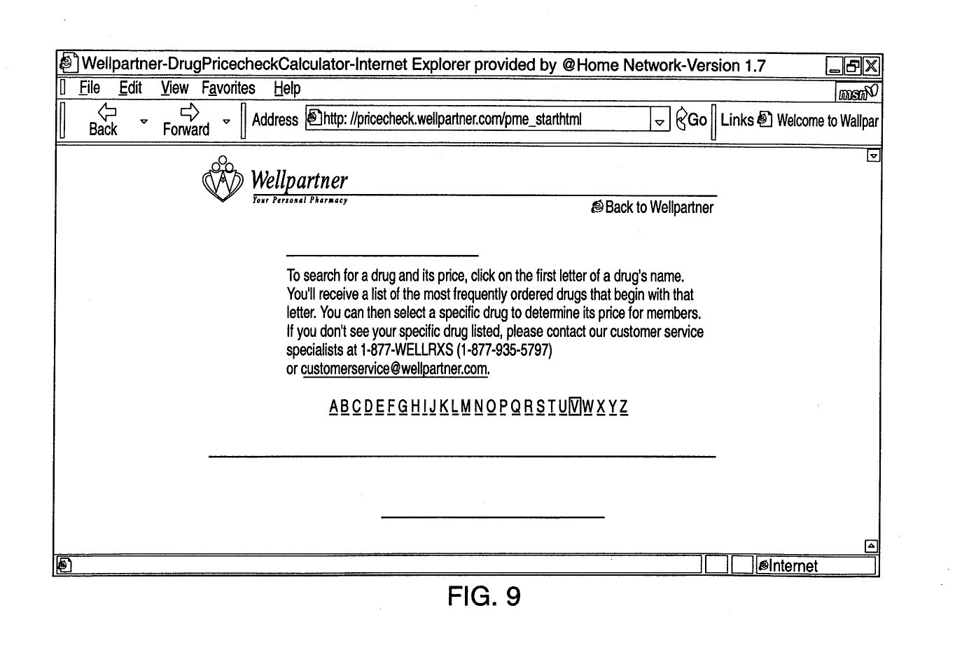

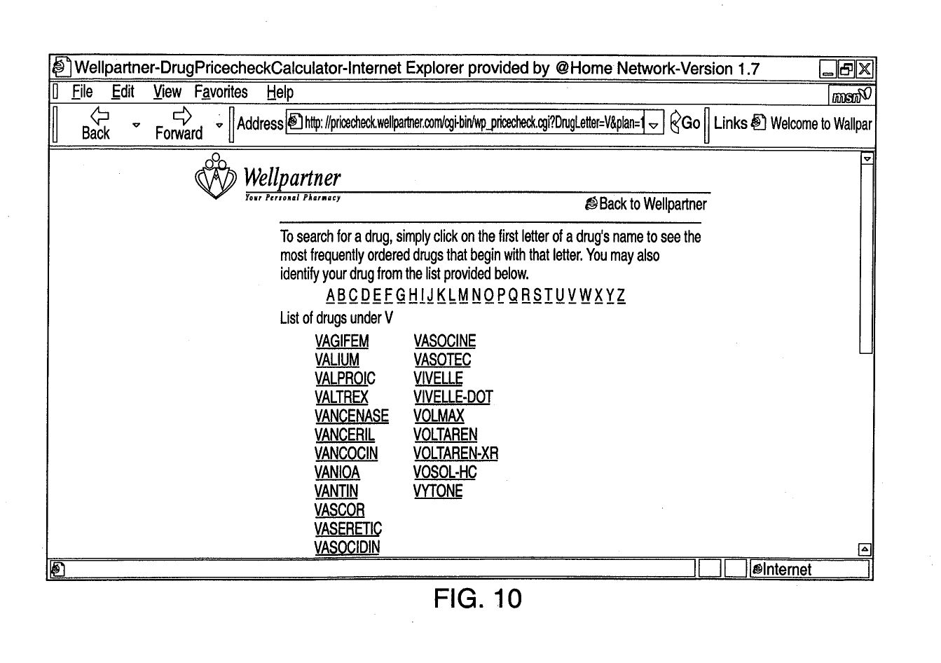

FIG. 9 illustrates a screen shot of the copay counselor resource allowing a user to search for a drug and calculate its price using an A-Z list in one embodiment of the present invention. This approach allows the user to simply click on the letter to see a list of drugs that start with that letter as shown in FIG. 10.

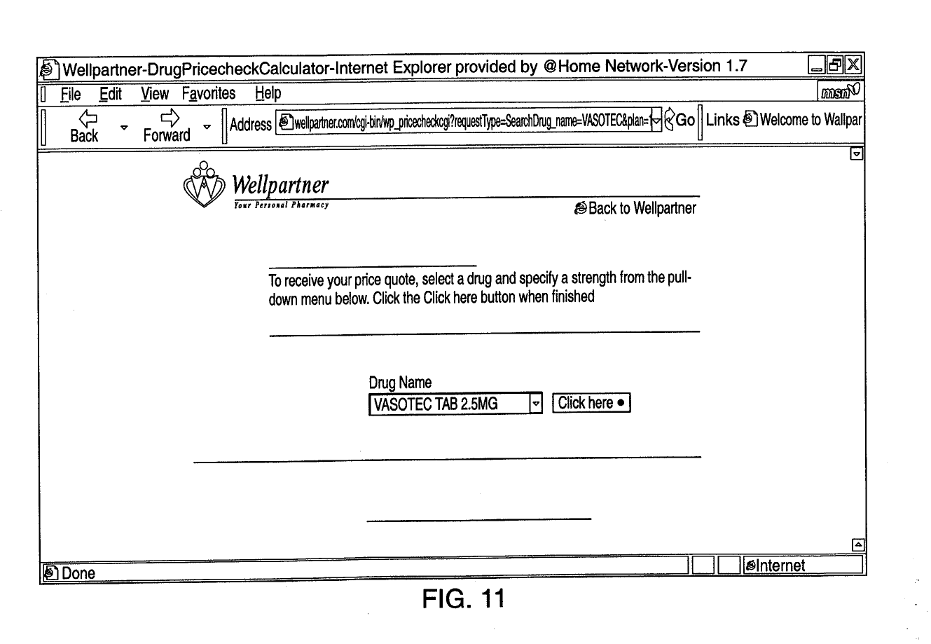

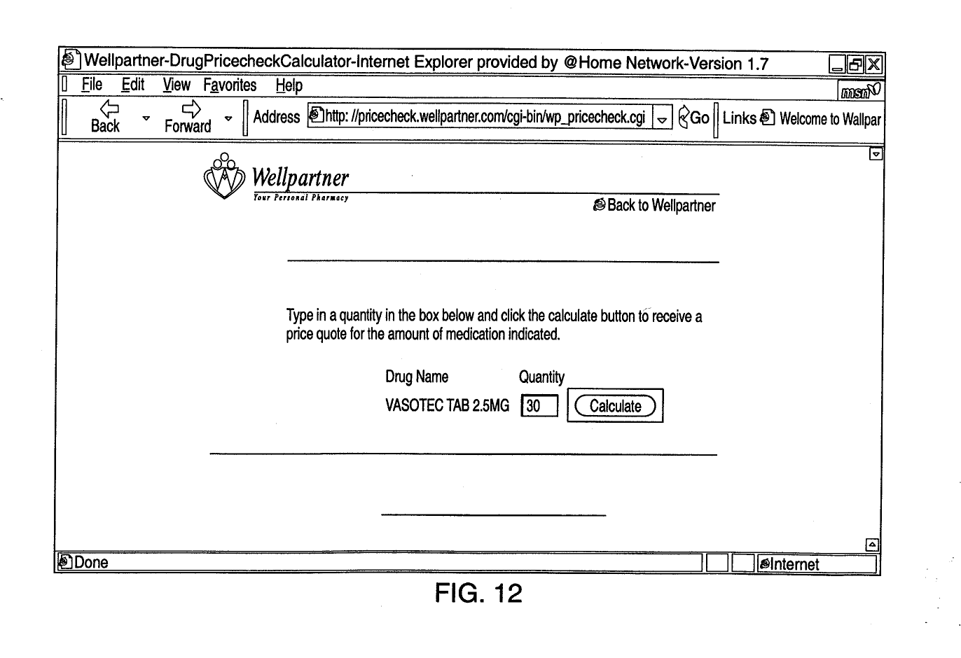

FIG. 11 and 12 illustrate screen shots of the copay counselor resource allowing a user to input the name of a drug and the quantity of a drug respectively. Namely, the user selects a dosage/strength level for the selected drug from pull-down menus, and enters a quantity/dosing amount to calculate the price for this drug.

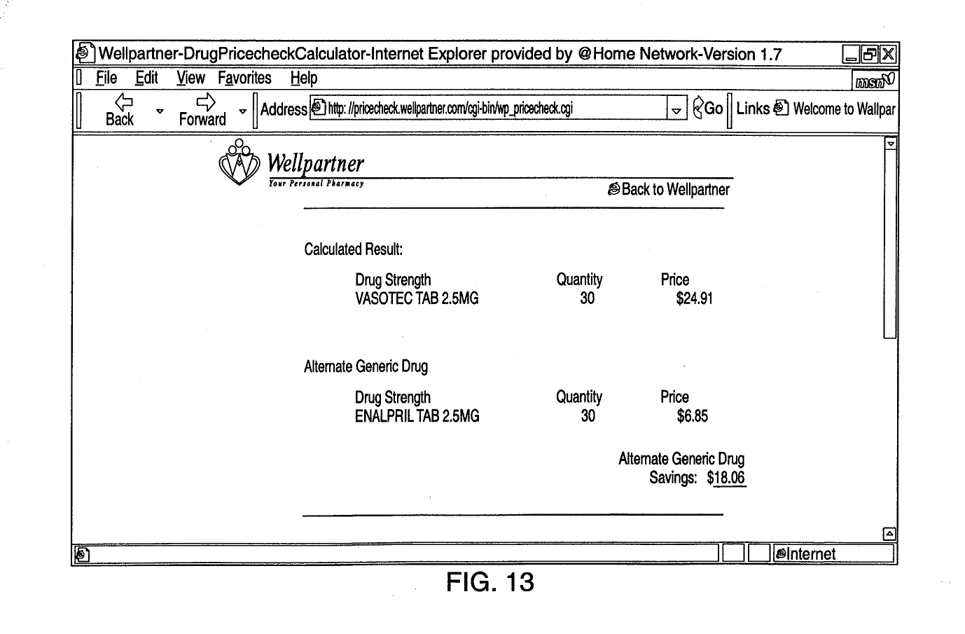

Finally, FIG. 13 illustrates a screen shot of the copay counselor resource displaying the comparison of a requested drug versus its generic equivalent and the associated cost savings. Thus, the Copay Counselor allows individuals to query about alternate medications and get relevant information, including prices, savings, “facts and comparisons”, and other information that informs about prescription medications uses and options. This resource can assist individuals in a variety of ways:

1. Conduct price check queries on prescription medications. Allows individuals to look up medications and calculate price based on a specified strength and dosing entered by the user;

2. Receive information on lower cost generic medication or lower priced brand name alternatives. Allows individuals to identify generic medication alternatives by returning generic and brand name alternatives for a specific brand name drug being searched; or/and

3. Identify lower copay prescription medications. Allow individuals to receive alerts about medications they are taking where other medications exist within a same therapeutic class and that have lower prescription co-payments than the medication for which the individual has a prescription.

This resource generally operates after an individual has registered with the health management and pharmacy service provider 130. In certain applications, the individual must complete a prescription profile, that identifies current active medications and refill quantities outstanding. Certain of these medications may be highlighted, or differentially called-out within the prescription profile. Highlighted medications may indicate that other medications exist within a same therapeutic class and have lower prices than the medication identified in the prescription profile. Individuals can select a medication and display information about the medication, including the product name, description, its generic alternative, price for that particular individual based on his/her payor profile3^{rd} party payor cost, and cash price.

The displayed information may be printed or emailed to an enrollee's Healthcare Practitioner. The information displayed may also be used to explore treatment options that can result in a lower cost to individuals and/or the prescription benefit provider.

When an individual uses the Copay Counselor to search for medication prices, it automatically identifies medications for which there is a cost or co-payment differential for generic or alternate medications within a same therapeutic category.

FIG. 14 illustrates a block diagram of a method of the present invention for providing a pharmaceutical prescription Copay Counselor as a standalone price check query tool. Namely, the user may not need to fill a prescription but simply want to identify less expensive alternatives for a particular drug. Thus, the present Copay Counselor can also be utilized by users who are not members of a prescription benefit plan.

In step 1405, method 1400 receives a prescription inquiry. For example, the user may select a drug name from an A-Z list in step 1410, followed by selecting the strength of the drug in step 1415, and followed by selecting the dosage or quantity of the drug in step 1420.

In step 1425, method 1400 retrieves the price information pertaining to the drug that is currently being requested, i.e., consulting the drug price database 1422.

In step 1430, method 1400 queries whether at least one alternate drug is available that is equivalent to the selected drug in step 1410. If the query is answered positively, method 1400 proceeds to step 1445 where the alternate drug price is retrieved. If the query is answered negatively, method 1400 proceeds to step 1435 where the price of the drug selected in step 1410 is presented to the user who generated the query. Method 1400 then ends in step 1440.

In step 1450, the potential alternatives to the requested drug are sorted in accordance with predefined sort rules, and displayed in step 1455. For example, the alternatives are listed in the order of the lowest price to the highest price. Method 1400 then ends in step 1460.

It should be noted that although certain sections of the present disclosure make reference to 3^{rd} party health plans, the present invention is not so limited. Namely, any user having a subset of benefits from such comprehensive health plans or other standalone benefit plans (e.g., only a prescription benefit or design) would also benefit from the use of the Copay Counselor and other resources as disclosed above.

Although various embodiments which incorporate the teachings of the present invention have been shown and described in detail herein, those skilled in the art can readily devise many other varied embodiments that still incorporate these teachings.

What is claimed is:

1. A method for providing a payment analysis pertaining to a prescribed medication purchase over a global set of interconnected computer networks, said method comprising the steps of:
a) receiving a request to fill a prescribed medication for a user;
b) retrieving personal information pertaining to said user from a user profile; and
c) correlating said request and said personal information to present at least one alternative medication to said prescribed medication.

2. The method of claim 1, wherein said retrieving step b) retrieves a benefit design of said user.

3. The method of claim 2, wherein said correlating step c) presents said at least one alternative medication and its price as compared to a price of said prescribed medication.

4. The method of claim 3, wherein said at least one alternative medication is sorted in an order that identifies a least expensive alternative medication as to a copay payable by said user.

5. The method of claim 4, wherein said at least one alternative medication is further sorted in an order that identifies a least expensive alternative medication as to a cost payable by a benefit provider of said user.

6. The method of claim 3, wherein said price of said at least one alternative medication is calculated using usual and customary price.

7. The method of claim 3, wherein said price of said at least one alternative medication is calculated using average wholesale price.

8. The method of claim 3, wherein said price of said at least one alternative medication is calculated using maximum allowable cost.

9. The method of claim 3, wherein said price of said at least one alternative medication is calculated using a third party reimbursed prescription benefit formulary.

10. The method of claim 1, further comprising the step of:
d) providing additional information pertaining to said at least one alternative medication to said user.

11. The method of claim 10, wherein said additional information comprises drug monograph information.

12. The method of claim 1, further comprising the step of:
d) forwarding said at least one alternative medication in an email message to a physician specified by said user.

13. A computer-readable medium having stored thereon a plurality of instructions, the plurality of instructions including instructions which, when executed by a processor, cause the processor to perform the steps comprising of:
a) receiving a request to fill a prescribed medication for a user;
b) retrieving personal information pertaining to said user from a user profile; and
c) correlating said request and said personal information to present at least one alternative medication to said prescribed medication.

14. The computer-readable medium of claim 13, wherein said retrieving step b) retrieves a benefit design of said user.

15. The computer-readable medium of claim 14, wherein said correlating step c) presents said at least one alternative medication and its price as compared to a price of said prescribed medication.

16. The computer-readable medium of claim 15, wherein said at least one alternative medication is sorted in an order that identifies a least expensive alternative medication as to a copay payable by said user.

17. The computer-readable medium of claim 16, wherein said at least one alternative medication is further sorted in an order that identifies a least expensive alternative medication as to a cost payable by a benefit provider of said user.

18. The computer-readable medium of claim 15, wherein said price of said at least one alternative medication is calculated using usual and customary price.

19. The computer-readable medium of claim 15, wherein said price of said at least one alternative medication is calculated using average wholesale price.

20. The computer-readable medium of claim 15, wherein said price of said at least one alternative medication is calculated using maximum allowable cost.

21. The computer-readable medium of claim 15, wherein said price of said at least one alternative medication is calculated using a third party reimbursed prescription benefit formulary.

22. The computer-readable medium of claim 13, further comprising the step of:
d) providing additional information pertaining to said at least one alternative medication to said user.

23. The computer-readable medium of claim 22, wherein said additional information comprises drug monograph information.

24. The computer-readable medium of claim 13, further comprising the step of:
d) forwarding said at least one alternative medication in an email message to a physician specified by said user.

25. An apparatus for providing a payment analysis pertaining to a prescribed medication purchase over a global set of interconnected computer networks, said apparatus comprising :
means for receiving a request to fill a prescribed medication for a user;
means for retrieving personal information pertaining to said user from a user profile; and
means for correlating said request and said personal information to present at least one alternative medication to said prescribed medication.

26. The apparatus of claim 25, wherein said retrieving means retrieves a benefit design of said user.

27. The apparatus of claim 26, wherein said correlating means presents said at least one alternative medication and its price as compared to a price of said prescribed medication.

28. The apparatus of claim 27, wherein said at least one alternative medication is sorted in an order that identifies a least expensive alternative medication as to a copay is payable by said user.

29. The apparatus of claim 28, wherein said at least one alternative medication is further sorted in an order that identifies a least expensive alternative medication as to a cost payable by a benefit provider of said user.

30. The apparatus of claim 27, wherein said price of said at least one alternative medication is calculated using usual and customary price.

31. The apparat us of claim 27, wherein said price of said at least one alternative medication is calculated using average wholesale price.

32. The apparatus of claim 27, wherein said price of said at least one alternative medication is calculated using maximum allowable cost.

33. The apparatus of claim 27, wherein said price of said at least one alternative medication is calculated using a third party reimbursed prescription benefit formulary.

34. The apparatus of claim 25, further comprising:
means for providing additional information pertaining to said at least one alternative medication to said user.

35. The apparatus of claim 34, wherein said additional information comprises drug monograph information.

36. The apparatus of claim 25, further comprising:
means for forwarding said at least one alternative medication in an email message to a physician specified by said user.

37. A method for providing a payment analysis pertaining to a prescribed medication purchase over a global set of interconnected computer networks, said method comprising the steps of:
a) receiving a query for a specified medication by a user;
b) retrieving a price for said specified medication; and
c) identifying at least one alternate medication to said specified medication;
d) retrieving a price for said at least one alternate medication and
e) displaying a price of said at least one alternate medication and said price for said specified medication.

38. The method of claim 37, wherein said displaying step e) displays both prices simultaneously to said user.

39. The method of claim 38, wherein said price of said at least one alternative medication is calculated using a usual and customary price.

40. The method of claim 38, wherein said price of said at least one alternative medication is calculated using an average wholesale price.

41. The method of claim 38, wherein said price of said at least one alternative medication is calculated using a maximum allowable cost.

42. The method of claim 38, wherein said price of said at least one alternative medication is calculated using a third party reimbursed prescription benefit formulary.

43. The method of claim 39, wherein said specified medication is a prescription drug.
